(19) United States
(12) Patent Application Publication
(10) Pub. No.: US 2021/0359291 A1
(43) Pub. Date: Nov. 18, 2021

(54) IRON-BEARING ELECTRODES FOR ELECTROCHEMICAL CELLS

(71) Applicant: FORM ENERGY INC.,, Somerville, MA (US)

(72) Inventors: Michael Andrew GIBSON, Philadelphia, PA (US); Yet-Ming CHIANG, Weston, MA (US); William Henry WOODFORD, Cambridge, MA (US)

(21) Appl. No.: 17/313,892

(22) Filed: May 6, 2021

Related U.S. Application Data
(60) Provisional application No. 63/021,610, filed on May 7, 2020.

(51) Int. Cl. H01M 4/136

(52) U.S. Cl. CPC H01M 4/136; H01M 2004/027

(57) ABSTRACT

Materials, designs, and methods of fabrication for electrodes for electrochemical cells are disclosed. In various embodiments, the electrode comprises iron. Various embodiments may include materials, systems, and methods for the use of various iron-bearing materials, starting from the discharged or partially discharged state in an alkaline electrochemical cell, such as an Fe—Ni, Fe—MnO₂, or Fe-air battery. Various embodiments may include a battery comprising an electrode comprising iron. In various embodiments, the iron may be in various forms, such as iron ore, iron concentrate, iron pellets, BF grade pellets, DR grade pellets, hematite, magnetite, wustite, martite, goethite, limonite, siderite, pyrite, ilmenite, spinel manganese ferrite, etc. In various embodiments, the iron may include impurity phases, such as SiO₂, CaO, etc.

### RELATED APPLICATIONS

This application claim priority to U.S. Provisional Application No. 63/021,610 filed May 7, 2020 entitled “Iron-Bearing Electrodes For Electrochemical Cells”, the entire contents of which are incorporated herein by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, >8 h) energy storage systems.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Materials, designs, and methods of fabrication for electrodes for electrochemical cells are disclosed. In various embodiments, the electrode comprises iron. Various embodiments may include materials, systems, and methods for the use of various iron-bearing materials, starting from the discharged or partially discharged state in an alkaline electrochemical cell, such as an Fe—Ni, Fe—MnO₂, or Fe-air battery. Various embodiments may include a battery comprising an electrode comprising iron. In various embodiments, the iron may be in various forms, such as iron ore, iron concentrate, iron pellets, BF grade pellets, DR grade pellets, hematite, magnetite, wustite, martite, goethite, limonite, siderite, pyrite, ilmenite, spinel manganese ferrite, etc. In various embodiments, the iron may include impurity phases, such as SiO₂, CaO, etc.

Various embodiments may include a battery, comprising: a first electrode; an electrolyte; and a second electrode, wherein one or both of the first electrode and the second electrode comprises iron. In various embodiments, the iron is in the form of iron ore. In various embodiments, the iron is in the form of concentrate, also known in the art as “iron ore fines” or “iron ore concentrate.” In various embodiments, the iron is in the form of at least one form selected from the group consisting of pellets, BF grade pellets, DR grade pellets, hematite, magnetite, wustite, martite, goethite, limonite, siderite, pyrite, ilmenite, and spinel manganese ferrite. In various embodiments, the iron comprises at least 0.1% SiO₂ by mass. In various embodiments, the iron comprises at least 0.25% SiO₂ by mass. In various embodiments, the iron comprises at least 0.5% SiO₂ by mass. In various embodiments, the iron comprises at least 0.1% CaO by mass. In various embodiments, the iron comprises at least 0.25% CaO by mass. In various embodiments, the iron comprises at least 0.5% CaO by mass.

### BRIEF DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIG. 1 is a schematic of an electrochemical cell, according to various embodiments of the present disclosure.

FIG. 2 is a schematic of an electrochemical cell including a composite metal electrode with spherical pellets and metal feedstock according to various embodiments of the present disclosure.

FIGS. 3-11 illustrate various example systems in which one or more aspects of the various embodiments may be used as part of bulk energy storage systems.

### DETAILED DESCRIPTION

References made to particular examples and implementations are for illustrative purposes and are not intended to limit the scope of the claims. The following description of the embodiments of the invention is not intended to limit the invention to these embodiments but rather to enable a person skilled in the art to make and use this invention.

The following examples are provided to illustrate various embodiments of the present systems and methods of the present inventions. These examples are for illustrative purposes, may be prophetic, and should not be viewed as limiting, and do not otherwise limit the scope of the present inventions.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention. Unless otherwise noted, the accompanying drawings are not drawn to scale.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular figure.

Embodiments of the present inventions include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

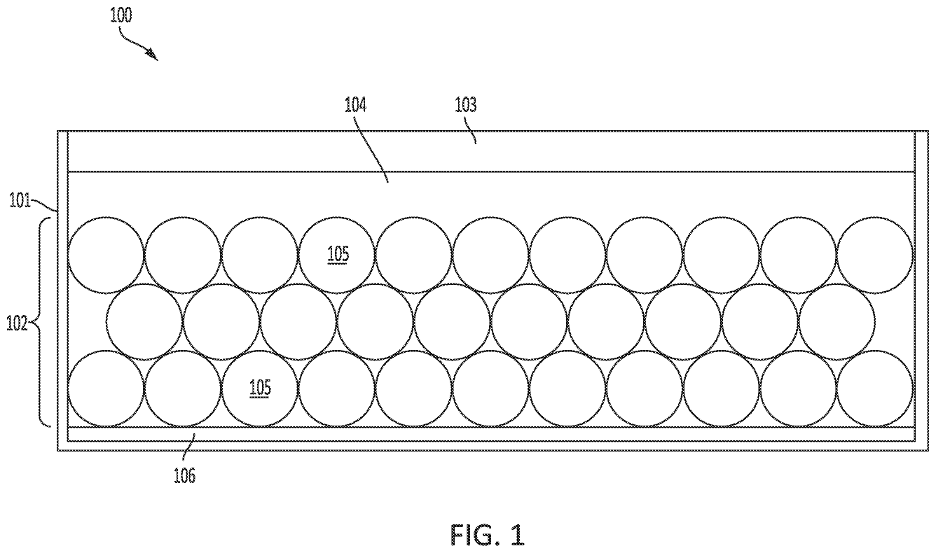

FIG. 1 is a schematic view of a battery (or cell) 100, according to various embodiments of the present disclosure. Referring to FIG. 1, the battery 100 may include a vessel 101 in which a positive electrode (such as an air electrode 103), a negative electrode 102, a liquid electrolyte 104, and a current collector 106 are disposed. The liquid electrolyte 104 may separate the electrode 103 from the negative electrode 102. As specific examples, the battery 100, positive electrode (e.g., the air electrode 103), electrolyte 104, the negative electrode 102, and/or current collector 106 may be any battery, positive electrode (e.g., any air electrode), electrolyte, negative electrode, and/or current collector described in U.S. Patent Application Publication No. 2020/0036002, U.S. Patent Application Publication No. 2021/0028452, and/or U.S. Patent Application Publication No. 2021/0028457, the entire contents of all three of which are hereby incorporated by reference for all purposes. One or more batteries 100 may be connected together in an energy storage system, such as a long-duration energy storage system, an ultra-long-duration energy storage system, etc.

In various embodiments, the electrolyte 104 may be any electrolyte known in the art, such as any electrolyte useful for iron alkaline batteries. The current collector 106 may be in the form of a conductive plate electrically connected to the negative electrode 102. However, the current collector 106 may have other configurations.

In various embodiments, the negative electrode 102 may be formed from and/or include a porous metal, such as porous iron. In various embodiments, the negative electrode 102 may be an alkaline electrode, such as an alkaline iron electrode. In various embodiments, the negative electrode 102 may include metallic pellets 105, such as metallic pellets 105 including iron. Accordingly, the pellets 105 may be referred to as iron-containing pellets. The pellets 105 may be electrically connected to one another and may be disposed in one or more layers to form the negative electrode 102. The pellets 105 may be spherical, as shown in FIG. 1. As used herein, the term “spherical” is used to describe any rounded form that resembles a three-dimensional object with all its surface points equidistant from its center, but in which all surface points may not actually be equidistant from the center. Stated another way, “spherical” encompasses shapes that are perfect spheres and shapes that may have the general appearance of a sphere by may not be perfect spheres, e.g., a ball. However, the present disclosure is not limited to any particular pellet 105 shape. For example, pellets 105 may be briquette-shaped. Additionally, while illustrated as whole pellets, the pellets 105 may be pieces of crushed pellets. In various embodiments, the pellets 105 may be produced from iron ore pellets, such as taconite or magnetite or hematite. In various embodiments, the pellets 105 may be produced by reducing iron ore pellets to form a more metallic (more reduced, less highly oxidized) material, such as iron metal (Fe⁰), wustite (FeO), or a mixture thereof. In various non-limiting embodiments, the pellets 105 may be reduced taconite, direct reduced (“DR”) taconite, direct reduced iron (“DRI”) pellets, or any combination thereof. In various embodiments, the packing of the pellets 105 in a bed to form the negative electrode 102 may create macro-pores in between individual pellets 105. Additionally, in various embodiments, the individual pellets 105 may each have a porous, e.g., micro-porous surface. The micro-pores in the surface of the pellets 105 may provide a greater surface area for each individual pellet 105 than if the pellet 105 were a smooth sphere. The pore size of the pellets 105 may vary.

Without being limited to any specific theory or model of the reactivity of the iron electrode (e.g., negative electrode 102), possible schemes for the oxidation of the iron electrode in alkaline electrolyte can proceed according to the following two reaction steps, Reaction 1 and Reaction 2 shown below in Table 1. Additional or different reaction products are possible (one of which is described in Reaction 3 below in Table 1), but the characteristics of voltage and volume change through the reaction are general to any oxidation product relative to metallic iron. That is—all oxidized products have a lower potential as measured vs. a standard reference such as the standard hydrogen electrode (SHE) than does metallic iron; similarly, oxidized products have a lower molar volume than does zero-valent iron.

TABLE 1

| | |
|---|---|
| Reaction 1: Fe + 2OH⁻ → Fe(OH)₂ + 2e⁻ | E⁰ = −0.88 V |
| | vs. SHE |
| Reaction 2: 3Fe(OH)₂ + 2OH⁻ → Fe₃O₄ + 4H₂O + 2e⁻ | E⁰ = −0.76 V |
| | vs. SHE |
| Reaction 3: Fe(OH)₂ + OH⁻ → FeOOH + H₂O + e⁻ | E⁰ = −0.61 V |
| | vs. SHE |

Tables 2A and 2B give some key physical properties of selected iron-containing materials which may be used as negative electrode 102 active materials in alkaline iron-based electrochemical cells, including batteries and metal-air batteries. The Pilling-Bedworth ratio is the ratio of the volume of the elementary cell of a metal oxide to the volume of the elementary cell of the corresponding metal (from which the oxide is created) and is a measure of the net volume change in one step of the reaction. In Tables 2A and 2B, the Pilling-Bedworth ratio is computed for the transformation from iron metal to the specified iron-bearing phase. Characteristics are listed down the left most column in each of Tables 2A and 2B.

TABLE 2A

| | Fe | Fe(OH)₂ | Fe₃O₄ | Fe₂O₃ | FeOOH | Fe(OH)₃ |
|---|---|---|---|---|---|---|
| Molar | 55.85 | 89.86 | 231.53 | 159.69 | 88.85 | 106.867 |
| mass | | | | | | |
| (g/mol) | | | | | | |
| Density | 7.87 | 3.40 | 5.17 | 5.24 | 4.25 | 3.90 |
| (g/cc) | | | | | | |
| Molar | 7.09 | 26.43 | 44.78 | 30.48 | 20.91 | 27.40 |
| volume | | | | | | |
| (cc/mol) | | | | | | |
| Volume | 7.09 | 26.43 | 14.93 | 15.24 | 20.91 | 27.40 |
| per mol Fe | | | | | | |
| (cc/mol) | | | | | | |
| Pilling- | — | 3.73 | 2.10 | 2.15 | 2.95 | 3.86 |
| Bedworth | | | | | | |
| Ratio | | | | | | |
| Theoretical | — | 959.76 | 1279.68 | 1439.64 | 1439.64 | 1439.64 |
| Specific | | | | | | |
| Capacity- | | | | | | |
| Direct | | | | | | |
| (mAh/gFe) | | | | | | |

TABLE 2B

| | FeCO₃ | FeS | FeS₂ | FeO | FeTiO₃ |
|---|---|---|---|---|---|
| Molar | 115.85 | 87.92 | 119.98 | 71.844 | 151.7 |
| mass | | | | | |
| (g/mol) | | | | | |
| Density | 3.90 | 4.84 | 5.00 | 5.74 | 4.72 |
| (g/cc) | | | | | |
| Molar | 29.71 | 18.17 | 24.00 | 12.52 | 32.14 |
| volume | | | | | |
| (cc/mol) | | | | | |
| Volume | 29.71 | 18.17 | 24.00 | 12.52 | 32.14 |
| per mol Fe | | | | | |
| (cc/mol) | | | | | |
| Pilling- | 4.19 | 2.56 | 3.38 | 1.76 | 4.53 |
| Bedworth | | | | | |
| Ratio | | | | | |
| Theoretical | 959.76 | 959.76 | 959.76 | 959.76 | 959.76 |
| Specific | | | | | |
| Capacity- | | | | | |
| Direct | | | | | |
| (mAh/gFe) | | | | | |

Electrochemical cells, such as battery 100, using iron-based materials as the negative electrode (e.g., negative electrode 102) may be assembled in either the charged state, in the discharged state, or at an intermediate state of charge. For example, using metallic iron as the active material in the as-assembled cell would start in the charged state. By contrast, starting with hematite (Fe₂O₃) in the as-assembled cell would start in the discharged state. Starting with Fe(OH)₂ in the as-assembled cell would constitute starting in an intermediate state of charge.

Various embodiments include materials, systems, and methods for the use of various iron-bearing materials, starting from the discharged or partially discharged state in an alkaline electrochemical cell (e.g., battery 100), such as an Fe—Ni, Fe—MnO₂, or Fe-air battery. In certain embodiments of the present inventions, the iron-bearing material comprises certain iron-bearing minerals, also known as iron ores. In certain cases, Mn-rich ores are referred to as “manganiferous ores.” Table 3 describes non-limiting examples of various common mineral forms of iron-bearing materials according to their mineral name, the general corresponding chemical formula, and the typical weight percentage of iron. Iron ores may comprise one or more of such iron-bearing minerals, as well as any other naturally-occurring mineral form comprising iron.

TABLE 3

| Mineral | Chemical Formula | Fe weight % |
|---|---|---|
| Hematite | Fe₂O₃ | 70.0 |
| Magnetite | Fe₃O₄ | 72.4 |
| Martite | xFe₂O₃•yFe₃O₄ | 70~72 |
| Goethite | Fe₂O₃•H₂O (2 FeOOH) | 62.9 |
| Limonite | 2Fe₂O₃•3H₂O | 59.8 |
| Siderite | FeCO₃ | 48.3 |
| Pyrite | FeS₂ | 46.6 |
| Ilmenite | FeTiO₃ | 36.8 |
| Wustite | FeO | 77.7 |
| Spinel Manganese Ferrite | FeMn₂O₄ | 24.3 |

Iron ores, may include an iron-bearing material such as (but not limited to) the mineral forms described in Table 3, along with impurity phases, such as SiO₂, Al₂O₃, TiO₂, CaO, MgO, and other impurity phases. Collectively, these impurity phases are called “gangue” phases in the art. Iron ores are mined and, as needed, concentrated or beneficiated to produce a high Fe content (generally >60 wt % Fe) for subsequent processing including but not limited to reduction via a blast furnace, direct reduction process (such as a shaft furnace reduction, rotary hearth, linear hearth, rotary kiln, or fluidized bed reduction). The main stages of processing or classification before reduction: include:
1) Mined ore. Ores are commonly classified according to their iron-content, and sometimes are classified as Low-grade, Medium-grade, or High-grade;
2) Direct shipping ores;
3) Beneficiated ores (“concentrate”, or “pellet feed”); and
4) Pelletizing (an agglomeration process). Common outputs here are referred to as Direct Reduction grade (“DR grade”) and Blast Furnace Grade (“BR grade).

Herein, the term “ore” will be used to refer to the material which is mined. The term “concentrate” will refer to the processed ore, which has had gangue phases preferentially removed to increase the Fe weight fraction. These concentrates are generally (thought not always) a powdery or slurry form. Typical compositions for various iron ores and concentrates are described in Table 4.

TABLE 4

| | Magnetite | | Magnetite | | Hematite | | Hematite | |
|---|---|---|---|---|---|---|---|---|
| | Concentrate | | Ore | | Concentrate | | Ore | |
| | Min | Max | Min | Max | Min | Max | Min | Max |
| Fe | 61.8 | 68.5 | 33 | 45 | 67.2 | 68.4 | 60.6 | 69 |
| (total) | | | | | | | | |
| FeO | 20.8 | 29.87 | 0 | 0 | 0 | 0 | 0 | 0 |
| Fe₂O₃ | 59.77 | 66.21 | 0 | 0 | 0 | 0 | 0 | 0 |
| SiO₂ | 4.1 | 12.5 | 0 | 0 | 1 | 2.5 | 0.41 | 5.1 |
| Al₂O₃ | 0.04 | 0.32 | 0 | 0 | 0.3 | 0.65 | 0.35 | 6 |
| CaO | 0.04 | 0.54 | 0 | 0 | 0 | 0 | 0 | 0 |
| MgO | 0.1 | 0.86 | 0 | 0 | 0 | 0 | 0 | 0 |
| S | 0.006 | 221 | 0 | 0 | 0 | 0 | 0.001 | 0.006 |
| P | 0.009 | 24 | 0.4 | 0.4 | 0 | 0 | 0.02 | 0.05 |
| K₂O | 0.03 | 0.032 | 0 | 0 | 0 | 0 | 0 | 0 |
| Na₂O | 0.06 | 0.06 | 0 | 0 | 0 | 0 | 0 | 0 |
| TiO₂ | 0.002 | 0.3 | 11 | 11 | 0 | 0 | 0 | 0 |
| Mn | 0 | 0 | 0 | 0 | 0 | 0 | 0 | 0 |
| V | 0 | 0 | 0 | 0 | 0 | 0 | 0 | 0 |
| Cu | 0 | 0 | 0 | 0 | 0 | 0 | 0 | 0 |
| Pb | 0 | 0 | 0 | 0 | 0 | 0 | 0 | 0 |
| Zn | 0 | 0 | 0 | 0 | 0 | 0 | 0 | 0 |
| Cr | 0 | 0 | 0 | 0 | 0 | 0 | 0 | 0 |
| V₂O₃ | 0 | 0 | 0.3 | 0.3 | 0 | 0 | 0 | 0 |

Ore sources are sometimes named according to their composition (e.g. “hematite,” or “magnetite”) and in other cases, they are named according to a specific geological formation. For example, one common source of iron ore in the United States is called “taconite,” which is a relatively low-grade iron ore comprising the mineral forms of magnetite, hematite, chert, siderite, greenalite, minnesotaite, and stilpnomelane. Taconite generally is mined with an iron content of 20-35 wt % Fe. Due to the low Fe content, taconite is typically beneficiated (the iron content is increased by removal of gangue phases). Taconite is beneficiated by crushing and grinding of the ore into a fine powder, followed by separation by flotation or magnetic separation to form the “concentrate” which comprises a higher weight percentage of iron than the raw taconite ore. This powder is then mixed with a binder, such as bentonite clay, and agglomerated to form pellets. Depending on the residual gangue content contained in the pellets, these may be classified as Blast Furnace grade (BF grade) or Direct Reduction grade (DR grade). The typical composition of DR Grade pellets are described in Table 5.

TABLE 5
DR Grade

| | Typical | Range |
|---|---|---|
| Fe wt % | 67 | 63-67 |
| FeO wt % | 0.5 | 0-2 |
| CaO wt % | 0.5 | 0-2 |
| MgO wt % | 0.25 | 0-2 |
| SiO₂ wt % | 2 | 0-4 |
| Al₂O₃ wt % | 0.26 | 0-4 |
| S wt % | 0.002 | <0.01 |
| P wt % | 0.028 | <0.05 |

The typical composition of BF Grade pellets are described in Table 6.

TABLE 6
BF Grade

| | Typical | Range |
|---|---|---|
| Fe wt % | 67 | 63-67 |
| FeO wt % | 0.5 | 0-2 |
| CaO wt % | 0.5 | 0-2 |
| MgO wt % | 0.25 | 0-2 |
| SiO₂ wt % | 5 | 2-7 |
| Al₂O₃ wt % | 0.26 | 0-4 |
| S wt % | 0.002 | <0.01 |
| P wt % | 0.028 | <0.05 |

Higher quality iron ores may have higher Fe content as mined, and do not require beneficiation. These are referred to as “direct shipping ores.”

One aspect of the present inventions is the use of iron ore materials in electrochemical cells, such as battery 100. Another aspect of the present inventions is the use of concentrate as active material in an electrochemical cell, such as battery 100. Another aspect of the present inventions is the use of BF grade pellets, such as pellets 105, in an electrochemical cell, such as battery 100. Another aspect of the present inventions is the use of DR grade pellets, such as pellets 105, in an electrochemical cell, such as battery 100. Another aspect of the present inventions is the use of combinations and variations of iron ores, concentrates, BF grade pellets, and DR grade pellets in an electrochemical cell, such as battery 100. According to the inventions, iron ores are beneficially used as redox-active electrodes in electrochemical cells, such as battery 100, including in storage batteries of primary (also referred to as “disposable”) or secondary (also referred to as “rechargeable”) type.

In another aspect of the inventions, iron ore materials, may be processed in such a way as to preferentially promote the presence of iron-containing phases which optimize for performance in an electrochemical device, such as battery 100. Performance metrics which may be so improved include, but are not limited to, specific capacity (measured in mAh/g), kinetic overpotentials, coulombic efficiency, cycle life, calendar life. As one example, the iron ore pellets 105 (both BF grade and DR grade) previously described are commonly processed in a way that promotes the presence of hematite, as such pellets 105 are produced primarily for use in steelmaking. Iron ore materials are beneficiated as previously described to produce a concentrate which contains both magnetite and hematite. After mixing with binder and agglomeration to form a pellet, these pellets are subjected to a heat treating step called “induration,” which serves to: 1) sinter the pellets to improve mechanical strength; and 2) to convert the magnetite to hematite. The time, temperature, and atmosphere are selected to promote this phase transformation according to the processes optimized for the use of these pellets in steelmaking (for example, in a blast furnace or in a direct reduction process). However, hematite is much less conductive than magnetite and hematite seems to be more difficult to reduce electrochemically than magnetite.

In one embodiment of the present inventions, these thermal processing steps, such as the heat-treating steps, may be eliminated, enabling the presence of a greater fraction of magnetite; such un-indurated pellets may be called “green pellets,” or “green bodies” in the art.

In another embodiment, the processing conditions, such as the heat-treating steps, may be selected to sinter the pellets, but selected in a way that maximizes the phase fraction of magnetite. In certain embodiments, the induration step involves exposure to oxygen such that the magnetite oxidizes to hematite. The partial pressure of the oxidation step may be controlled to remain in a magnetite field instead of entering the hematite field. In certain embodiments, the time and temperature are selected to promote sintering, but to minimize coarsening of the iron ore grains, such that the primary particle size remains fine. In certain embodiments, the primary particle size of the magnetite grains is less than 500 microns (micron=10⁻⁶ m), or less than 100 microns, or less than 50 microns.

In certain embodiments, the iron ore is subsequently fabricated into electrodes by thermochemical reduction, such as a negative electrode 102, positive electrode 103, etc. In some embodiments, the reduction may proceed almost to complete reduction of the iron oxides to metallic iron. Nearly complete reduction of the iron oxide to metallic iron is the goal of many industrial thermochemical reduction processes for iron.

In other embodiments, the iron ore is incompletely reduced to metallic iron. There are several reasons why such incompletely-reduced products may be particularly useful for iron batteries. First, several of the oxide phases created during the reduction of iron are semiconducting, and thus may usefully serve as electronic conductors in an iron electrode material. For example, magnetite is fairly conductive close to room temperature. Wüstite, while less conductive than magnetite, is still highly conductive relative to most oxides. In some embodiments, one may take advantage of the semiconducting nature of wustite and magnetite to form a battery electrode which is may be a composite with metallic iron. Partially reduced products may also be more electrochemically active. The inventors have observed that wüstite may in some circumstances be more electrochemically active than even metallic iron. Wüstite may be less expensive to thermochemically reduce due to its higher oxidation state than metallic iron. Wüstite may therefore be both less expensive and higher performance than metallic iron as a component of a battery electrode (e.g., electrode 102, 103, etc.).

In one aspect, a negative electrode (e.g., 102) for an alkaline iron battery (e.g., 100) may be produced from indurated pellets composed of hematite traditionally fed to direct reduction or blast furnace processes. The pellets may be reduced in a vertical shaft furnace via appropriate mixtures of hydrocarbons and other reducing gases known in the art of the direct reduction of iron. The reduction process may terminate when a metallization of at most 95% is achieved (metallization is a term used in the art of direct reduction of iron to describe the fraction of iron atoms which are fully metallic in their oxidation state). In some instances, a lower metallization may be preferred, with metallizations as low as 0% yielding large quantities of magnetite and wüstite as alternative input materials for a battery (e.g., 100). The resulting partially reduced pellets, lump, fragment or other particulate may be packed into a bed of particles in order to serve as an iron electrode material, such as a bed of pellets 105 forming electrode 102. The electrode material may consist entirely of iron oxides, and comprise primarily a mixture of magnetite and wustite.

The iron ore materials comprising the electrodes, devices, and systems of the inventions may have a wide range of purities, and indeed may have relatively high impurity concentrations compared to iron-bearing materials that are synthesized from purified sources of iron. Table 7 lists several of the more commonly found impurities in iron ores, and their typical ranges of concentration in weight percentage. In some aspects of the inventions, said iron ore materials may have at least a minimum amount of such naturally-occurring impurities, singly or in combination.

TABLE 7

| Component | Low | Mid | High |
|---|---|---|---|
| SiO₂ wt % | 0.05 | 4 | 7 |
| Al₂O₃ wt % | 0.02 | 0.04 | 6 |
| CaO wt % | 0.02 | 0.5 | 5 |
| MgO wt % | 0.05 | 0.25 | 3 |
| TiO₂ wt % | 0.0001 | 0.3 | 12 |

Non-limiting advantages to the use of iron ores in such applications include low cost and widespread availability of the ores. The use of such ores does not preclude the selection of the ores for particular physical and chemical characteristics, nor does it preclude further processing of the ores (as in the example of concentrates, BF grade pellets, and DR grade pellets).

In certain embodiments, the presence of certain impurity phases is preferentially increased, to derive additional performance benefits in an electrochemical cell using an alkaline electrolyte. For example, alkaline electrolytes are subject to reaction with carbon dioxide (CO₂) to form carbonate anions (CO₃²⁻) which is well-known in the art as a degradation mechanism of such electrolytes. CaO, when contacted with water, will react to form Ca(OH)₂ according to CaO+H₂O->Ca(OH)₂. Ca(OH)₂ is known to react with CO₃²⁻ to trap carbonate as CaCO₃ and release hydroxide ions OH—. Thus, the presence of CaO in the iron material provides for a carbonate sink, which scrubs carbonate from the alkaline electrolyte. Analogous reactions may use MgO and BaO as well. In certain embodiments, the mass fraction of CaO is selected to be as high as possible to provide maximum carbonate trapping capability.

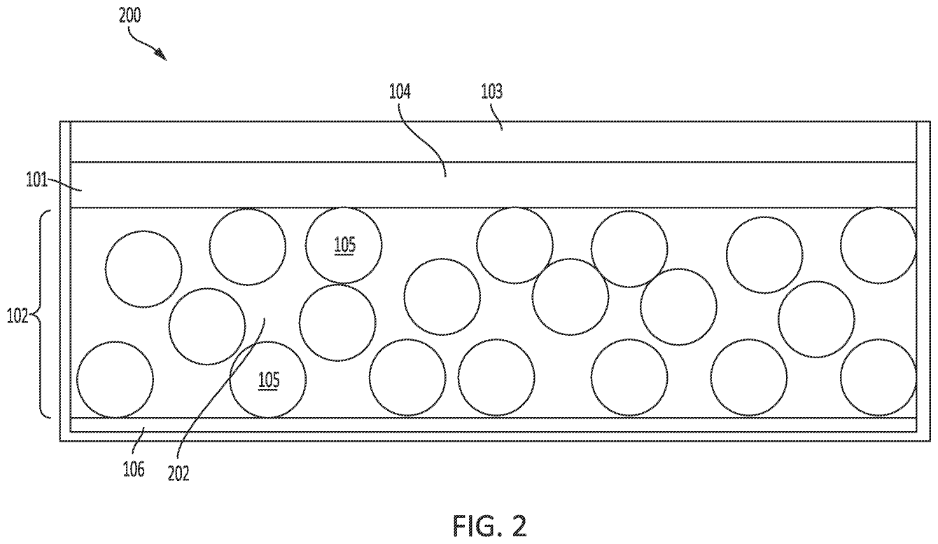

In various embodiments, the electrodes (e.g., 102, 103, etc.) and devices of the inventions, in addition to comprising iron ores, may comprise other materials. Electrodes (e.g., 102, 103, etc.) of the inventions may comprise a composite which may include said iron ore or ores mixed with DRI pellets and/or smaller metal particles such as metal fines or shavings. For example, as illustrated in FIG. 2, the negative electrode 102 may include spherical pellets 105 comprised of taconite and a smaller metal particle composition 202 comprised of conductive material. FIG. 2 is a schematic of a battery 200 according to various embodiments of the present disclosure. The battery 200 is similar to the battery 100, so only differences between the batteries 100 and 200 will be discussed in detail. By combining low-cost taconite pellets used as a bulk iron feedstock for the pellets 105 and a conductive additive 202, the cost of forming a conductive electrode upon assembly of the battery 200 may be lowered. As other examples, the composite metal electrode architecture may include a mixture of different sized iron ore particles, such as larger iron ore pellets (e.g., taconite, DRI, sponge iron, atomized iron, etc.) and a smaller metal particle composition, such as metal fines or shavings (e.g., fines or shavings of DRI, taconite, sponge iron, atomized iron, etc.).

The iron ores used for the purposes herein may be selected, or further processed or treated, to improve certain physical characteristics. These characteristics include, but are not limited to, improved electrical conductivity, improved surface or interfacial reaction kinetics, and accommodation of the volume change induced by electrochemical transformation during cycling, as characterized at least in part by the Pilling-Bedworth ratio illustrated in Tables 2A and 2B.

In some embodiments, the electrical conductivity of the metal electrode is increased by adding conductive fibers, wires, mesh, or sheets to the pellets such that the conductive material is dispersed between individual pellets. For example, the conductive fibers, wires, mesh, or sheets may be added as part of the conductive additive 202. In one embodiment, the conductive fiber comprises copper or iron. In another embodiment, the fiber is a chopped fiber. In another embodiment, the fiber is iron, and its diameter is selected to be larger than the thickness of iron that is reversibly oxidized and reduced as the battery is discharged and charged. Accordingly, the interior of the fiber remains as metallic iron as the electrode (e.g., 102), including said fiber participates in the electrochemical reaction of the cell (e.g., 200), maintaining a metallic conductive path within the electrode. In another embodiment, said fibers are sintered to the iron ore in fabricating the electrode (e.g., 200).

In other embodiments, a conductive additive (e.g., 202) is added to the mineral form comprising iron. Without being bound by any particular scientific interpretation, said conductive additive may facilitate electrochemical reactions of the iron by providing electronically conductive pathways for electrons to be conveyed to and from the redox-active iron sites. Said conductive additive may be almost any electronically conductive material including but not limited to metals, metal carbides, metal nitrides, metal oxides, and allot-ropes of carbon including carbon black, carbon black of high structure, graphitic carbon, carbon fibers, carbon microfibers, vapor-grown carbon fibers (VGCF), fullerenic carbons including “buckyballs”, carbon nanotubes (CNTs), multiwall carbon nanotubes (MWNTs), single wall carbon nanotubes (SWNTs), graphene sheets or aggregates of graphene sheets, and materials comprising fullerenic fragments. An electronically conductive poly-mer, including but not limited to polyaniline or polyacetylene based conductive polymers or poly(3,4-ethylenediox-ythiophene) (PEDOT), polypyrrole, polythiophene, poly(p-phenylene), poly(triphenylene), polyazulene, polyfluorene, polynaphtalene, polyanthracene, polyfuran, polycarbazole, tetrathiafulvalene-substituted polystyrene, ferrocene-substituted polyethylene, carbazole-substituted polyethylene, polyoxyphenazine, polyacenes, or poly(heteroacenes).

In some embodiments, the conductive additive (e.g., 202) comprises an ore or metal salt. In some embodiments, said ore or metal salt is reduced thermochemically or electrochemically to a more highly electronically conductive form. In some embodiments, said more highly electronically conductive form comprises a metal salt, such as a metal oxide, or a metal. In some embodiments, the ore or metal salt yielding the conductive additive is selected to have a less negative free energy of formation (i.e., is more noble) than the iron ore or mineral or salt comprising the electrode, and may be preferentially reduced over the iron ore or mineral or salt. As a non-limiting example, the metal comprising the conductive additive may be produced from a starting ore or mineral form of the metal by thermochemical reduction to the metallic form. In some embodiments, the conductive additive comprises Ni, Co, Cu, Zn, Sn, brass, bronze, or Ag.

In one particular embodiment, the conductive additive (e.g., 202) comprises copper, and is made by adding a copper ore to the iron ore and subsequently heating the mixture at a temperature and a reducing gaseous environment whereby the copper ore is reduced to metallic copper. Optionally, the reducing environment may comprise hydrogen gas. In some embodiments, the copper wets the surfaces of the iron ore and infiltrates or partially infiltrates the iron ore. Optionally, the electrode (e.g., 102) may be heat treated below the melting point of the copper to allow the solid copper to subsequently dewet the iron ore.

In another such embodiment, copper metal and the iron ore, or a copper ore and the iron ore, are heat treated and co-sintered to produce a composite electrode (e.g., 102) with high electronic conductivity provided by the metallic copper constituent.

In some embodiments, the conductive additive and the iron ore material are arranged in physical proximity and size scale to provide for improved transport of electrons and ions to the redox-active microscopic regions of the electrode (e.g., 102). In some embodiments, the conductive additive may form a continuous, percolating network through the electrode (e.g., 102). In other embodiments, the iron ore is in the form of particles, and the conductive additive substantially coats the surface of the particles. In some embodiments, the conductive additive preferably comprises less than 20% by volume of the combined volume of the iron ore and the conductive additive, preferably less than 10% by volume, and still preferably less than 5% by volume.

Even when electronic conductivity is improved through addition of a conductive additive (e.g., 202), other factors such as the particle size of the iron ore may affect the rate of the electrochemical reactions, and correspondingly, the charge and/or discharge rate and efficiency of the electrode (e.g., 102). While fine particles may have a higher surface area for electrochemical reaction and a smaller cross-sectional dimension for electron or ion transport, and thereby improve the rate of electrochemical reactions, they may also be more subject to the influence of passivating (that is, electrically insulating) surface layers that may form in service, and may be more costly to produce from mined materials. For the purposes of the present discussion, the primary particle size is considered to be the size of a solid particle generally free of internal porosity, whereas the secondary particle size is that of a collection of bound primary particles. Accordingly, the pellets of iron ore materials referred to previously constitute secondary particles. In some embodiments, the iron ore primary particles or the iron ore secondary particles comprising the electrodes, devices, and systems of the inventions have a mean particle size corresponding to about a 325 mesh size (less than about 44 micrometers). In other embodiments, the iron ore particles have a mean primary particle size less than about 10 micrometers. In some embodiments, the iron ore particles have a primary particle size greater than about 10 micrometers, preferably greater than about 15 micrometers, and still more preferably greater than about 20 micrometers.

In general, the secondary particles comprising the iron ore electrodes (e.g., 102) of the inventions, which include pelletized forms of the iron ores, should have substantial porosity, for at least two reasons. First, the porosity enables infiltration of the electrode secondary particle or pellet by the electrolyte of the electrochemical cell. Second, the porosity also accommodates the change in volume of the iron ore material as it is cycled between a discharged (oxidized) state and a charged (reduced) state. As illustrated in Tables 2A and 2B, the Pilling-Bedworth ratio of iron-bearing minerals can be a factor of 2 to 5. Accordingly, the porosity of the electrode (e.g., 102) comprising the conductive additive and iron ore material, not including changes in volume due to subsequent electrochemical operation of the battery (e.g., 100, 200) is, by volume, preferably between 10% and 80%, more preferably between 20% and 70%, and still more preferably between 30% and 50%. In some embodiments, at least 70% of said porosity is filled with a liquid electrolyte (e.g., 104), preferably more than 80%, and still more preferably, more than 90%.

In some embodiments, the conductive additive forms a porous structure with cavities within which particles of the iron ore reside, thereby allowing free volume surrounding the iron ore particles to permit expansion and contraction, while the iron ore particle remains electrically connected to a continuous structure of the conductive additive (e.g., 202). In some such structures, the cavity in the porous conductive structure is equiaxed. In other embodiments, the cavities are anisometric, and may be extended in one dimension in the form of tubes, or in two dimensions to form plate-like cavities of various aspect ratios.

In some embodiments, the electrode (e.g., 102) of the inventions is a composite comprising the iron ore and an added material that provides elastic compliance to the electrode (e.g., 102), thereby permitting repeated expansion and contraction of the redox-active material during discharge and charge. In some embodiments the added material is a polymer or polymeric binder. In some instances, the conductive additive (e.g., 202) is also said compliant material. Examples of polymeric binders suitable for use in various embodiments include sodium carboxymethyl cellulose (Na-CMC), lithium carboxymethyl cellulose (Li-CMC), potassium carboxymethyl cellulose (K-CMC), polyacrylic acid (PAA), polyacrylamide, polyether ether ketone (SPEEK), sulfonated polyether ether ketone (SPEEK). In some embodiments, the polymeric binder is also electronically conductive and examples of such polymers include trans-polyacetylene, polythiopene, polypyrrole, poly(p-phyenylene), polyaniline, poly(p-phenylene vinyelene), poly(3,4-ethylenedioxythiophene) polystyrene sulfonate (PEDOT:PSS).

Various embodiments are discussed in relation to the use of direct reduced iron (DRI) as a material in an electrochemical system (e.g., a battery (or cell), etc.), as a component of an electrochemical system (e.g., a battery (or cell), etc.), and combinations and variations of these. In various embodiments, the DRI may be produced from, or may be, material which is obtained from the reduction of natural or processed iron ores, such reduction being conducted without reaching the melting temperature of iron. In various embodiments the iron ore may be taconite or magnetite or hematite or goethite, etc. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less highly oxidized) material, such as iron metal (Fe⁰), wustite (FeO), or a composite pellet comprising iron metal and residual oxide phases. In various non-limiting embodiments, the DRI may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced iron (CDRI)” pellets, direct reduced iron (“DRI”) pellets, Hot Briquetted iron (HBI), or any combination thereof. In the iron and steelmaking industry, DRI is sometimes referred to as “sponge iron;” this usage is particularly common in India. Embodiments of iron materials, including for example embodiments of DRI materials, for use in various embodiments described herein, including as electrode materials, may have, one, more than one, or all of the material properties as described in Table 8 below. As used in the Specification, including Table 8, the following terms, have the following meaning, unless expressly stated otherwise: “Specific surface area” means, the total surface area of a material per unit of mass, which includes the surface area of the pores in a porous structure; “Carbon content” or “Carbon (wt %)” means the mass of total carbon as percent of total mass of DRI; “Cementite content” or “Cementite (wt %)” means the mass of Fe₃C as percent of total mass of DRI; “Total Fe (wt %)” means the mass of total iron as percent of total mass of DRI; “Metallic Fe (wt %)” means the mass of iron in the Fe⁰ state as percent of total mass of DRI; and “Metallization” means the mass of iron in the Fe⁰ state as percent of total iron mass. Weight and volume percentages and apparent densities as used herein are understood to exclude any electrolyte that has infiltrated porosity or fugitive additives within porosity unless otherwise stated.

TABLE 8

| Material Property | Embodiment Range |
|---|---|
| Specific surface area* | 0.01-25 m²/g |
| Actual density** | 4.6-7.1 g/cc |
| Apparent density*** | 2.3-6.5 g/cc |
| Minimum d_{pore, 90% volume}**** | 10 nm-50 μm |
| Minimum d_{pore, 50% surface area}***** | 1 nm-15 μm |
| Total Fe (wt %)^{#} | 65-95% |
| Metallic Fe (wt %)^{##} | 46-90% |
| Metallization (%)^{###} | 59-96% |
| Carbon (wt %)^{####} | 0-5% |
| Fe²⁺ (wt %)^{#####} | 1-9% |
| Fe³⁺ (wt %)^{$} | 0.9-25% |
| SiO₂ (wt %)^{$$} | 1-15% |
| Ferrite (wt %, XRD)^{$$$} | 22-97% |
| Wustite (FeO, wt %, XRD)^{$$$$} | 0-13% |
| Goethite (FeOOH, wt %, XRD)^{$$$$$} | 0-23% |
| Cementite (Fe₃C, wt %, XRD)⁺ | «80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption′ and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results.
Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results.
Porosity may be defined as the ratio of apparent density to actual density:
$\text{Porosity} = \frac{\text{apparent density}}{\text{actual density}}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results.
d_{pore, 90% volume} is the pore diameter above which 90% of the total pore volume exists.
*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results.
d_{pore, 50% surface area} is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
^{$}Fe³⁺ (wt %) preferably determined by the mass balance relation between and among Total Fe (wt %), Metallic Fe (wt %), Fe²⁺ (wt %) and Fe³⁺ (wt %).
Specifically the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) − Metallic Fe (wt %) − Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods.
In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$$}Goethite (FeOOH, wt %, XRD) preferably determined by x-ray diffraction (XRD).
⁺Cementite (Fe₃C, wt %, XRD) preferably determined by x-ray diffraction (XRD).

Additionally, embodiments of iron materials, including for example embodiments of DRI materials, for use in various embodiments described herein, including as electrode materials, may have one or more of the following properties, features or characteristics, (noting that values from one row or one column may be present with values in different rows or columns) as set forth in Table 8A.

TABLE 8A

| | | | | |
|---|---|---|---|---|
| Fe total (wt %)^{!} | >60% | >70% | >80% | ~83-94% |
| SiO₂ (wt %)^{!!} | <12% | <7.5% | 1-10% | 1.5-7.5% |
| Al₂O₃ (wt %)^{!!!} | <10% | <5% | 0.2-5% | 0.3-3% |
| MgO (wt %)^{!!!!} | <10% | <5% | 0.1-10% | 0.25-2% |
| CaO (wt %)^{!!!!!} | <10% | <5% | 0.9-10% | 0.75-2.5% |
| TiO₂ (wt %)^{&} | <10% | <2.5% | 0.05-5% | 0.25-1.5% |
| Size (largest | <200 mm | ~50 to | ~2 to ~30 mm | ~4 to ~20 mm |
| cross-sectional | | ~150 mm | | |
| distance, e.g. | | | | |
| for a sphere | | | | |
| the diameter) | | | | |
| Actual Density | ~5 | ~5.8 to ~6.2 | ~4.0 to ~6.5 | <7.8 |
| (g/cm³)^{&&} | | | | |
| Apparent | <7.8 | >5 | >4 | 3.4~3.6 |
| Density | | | | |
| (g/cm³)^{&&&} | | | | |
| Bulk Density | <7 | >1.5 | ~2.4 to ~3.4 | ~1.5 to ~2.0 |
| (kg/m³)^{&&&&} | | | | |
| Porosity | >15% | >50% | ~20% to ~90% | ~50% to ~70% |
| (%)^{&&&&&} | | | | |

^{!}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{!!}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods.
In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{!!!}Al₂O₃ (wt %) preferably determined by flame atomic absorption spectrometric method, and more preferably as is set forth in ISO 4688-1 (the entire disclosure of which is incorporated herein by reference); recognizing that other tests, such as x-ray diffraction (XRD), may be employed to provide results that can be correlated with flame atomic absorption spectrometric method.
In certain methods, the Al₂O₃ wt % is not determined directly, but rather the Al concentration (inclusive of neutral and ionic species) is measured, and the Al₂O₃ wt % is calculated assuming the stoichiometry of Al₂O₃; that is, a 2:3 molar ratio of Al:O is assumed.
^{!!!!}MgO (wt %) preferably determined by flame atomic absorption spectrometric method, and more preferably as is set forth in ISO 10204 (the entire disclosure of which is incorporated herein by reference); recognizing that other tests, such as x-ray diffraction (XRD), may be employed to provide results that can be correlated with flame atomic absorption spectrometric method.
In certain methods, the MgO wt % is not determined directly, but rather the Mg concentration (inclusive of neutral and ionic species) is measured, and the MgO wt % is calculated assuming the stoichiometry of MgO; that is, a 1:1 molar ratio of Mg:O is assumed.
^{!!!!!}CaO (wt %) preferably determined by flame atomic absorption spectrometric method, and more preferably as is set forth in ISO 10203 (the entire disclosure of which is incorporated herein by reference); recognizing that other tests, such as x-ray diffraction (XRD), may be employed to provide results that can be correlated with flame atomic absorption spectrometric method.
In certain methods, the CaO wt % is not determined directly, but rather the Ca concentration (inclusive of neutral and ionic species) is measured, and the CaO wt % is calculated assuming the stoichiometry of CaO; that is, a 1:1 molar ratio of Ca:O is assumed.
^{&}TiO₂ (wt %) preferably determined by a diantipyrylmethane spectrophotometric method, and more preferably as is set forth in ISO 4691 (the entire disclosure of which is incorporated herein by reference); recognizing that other tests, such as x-ray diffraction (XRD), may be employed to provide results that can be correlated with the diantipyrylmethane spectrophotometric method method.
In certain methods, the TiO₂ wt % is not determined directly, but rather the Ti concentration (inclusive of neutral and ionic species) is measured, and the TiO₂ wt % is calculated assuming the stoichiometry of TiO₂; that is, a 1:2 molar ratio of Ti:O is assumed.
^{&&}Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results.
Actual density may also be referred to as “true density” or “skeletal density” in the art.
^{&&&}Apparent density preferably determined by immersion in water, and more preferably as is set forth in ISO 15968 (the entire disclosure of which is incorporated herein by reference); recognizing that other tests may be employed to provide results that can be correlated with He pycnometry results.
^{&&&&}Bulk Density (kg/m³) preferably determined by measuring the mass of a test portion introduced into a container of known volume until its surface is level, and more preferably as is set forth in Method 2 of ISO 3852 (the entire disclosure of which is incorporated herein by reference); recognizing that other tests may be employed to provide results that can be correlated with the massing method.
^{&&&&&}Porosity determined preferably by the ratio of the apparent density to the actual density:
$\text{Porosity} = \frac{\text{apparent density}}{\text{actual density}}$

The properties set forth in Table 8A, may also be present in embodiments with, in addition to, or instead of the properties in Table 8. Greater and lesser values for these properties may also be present in various embodiments.

In embodiments the specific surface area for the pellets can be from about 0.05 m²/g to about 35 m²/g, from about 0.1 m²/g to about 5 m²/g, from about 0.5 m²/g to about 10 m²/g, from about 0.2 m²/g to about 5 m²/g, from about 1 m²/g to about 5 m²/g, from about 1 m²/g to about 20 m²/g, greater than about 1 m²/g, greater than about 2 m²/g, less than about 5 m²/g, less than about 15 m²/g, less than about 20 m²/g, and combinations and variations of these, as well as greater and smaller values.

In general, iron ore pellets are produced by crushing, grinding or milling of iron ore to a fine powdery form, which is then concentrated by removing impurity phases (so called “gangue”) which are liberated by the grinding operation. In general, as the ore is ground to finer (smaller) particle sizes, the purity of the resulting concentrate is increased. The concentrate is then formed into a pellet by a pelletizing or balling process (using, for example, a drum or disk pelletizer). In general, greater energy input is required to produce higher purity ore pellets. iron ore pellets are commonly marketed or sold under two principal categories: Blast Furnace (BF) grade pellets and Direct Reduction (DR Grade) (also sometimes referred to as Electric Arc Furnace (EAF) Grade) with the principal distinction being the content of SiO₂ and other impurity phases being higher in the BF grade pellets relative to DR Grade pellets. Typical key specifications for a DR Grade pellet or feedstock are a total Fe content by mass percentage in the range of 63-69 wt % such as 67 wt % and a SiO₂ content by mass percentage of less than 3 wt % such as 1 wt %. Typical key specifications for a BF grade pellet or feedstock are a total Fe content by mass percentage in the range of 60-67 wt % such as 63 wt % and a SiO₂ content by mass percentage in the range of 2-8 wt % such as 4 wt %.

In certain embodiments the DRI may be produced by the reduction of a “Blast Furnace” pellet, in which case the resulting DRI may have material properties as described in Table 9 below. The use of reduced BF grade DRI may be advantageous due to the lesser input energy required to produce the pellet, which translates to a lower cost of the finished material.

TABLE 9

| Material Property | Embodiment Range |
|---|---|
| Specific surface area* | 0.21-25 m²/g |
| Actual density** | 5.5-6.7 g/cc |
| Apparent density*** | 3.1-4.8 g/cc |
| Minimum d_{pore, 90% volume}**** | 50 nm-50 μm |
| Minimum d_{pore, 50% surface area}***** | 1 nm-10 μm |
| Total Fe (wt %)^{#} | 81.8-89.2% |
| Metallic Fe (wt %)^{##} | 68.7-83.2% |
| Metallization (%)^{###} | 84-95% |
| Carbon (wt %)^{####} | 0.03-0.35% |
| Fe²⁺ (wt %)^{#####} | 2-8.7% |
| Fe³⁺ (wt %)^{$} | 0.9-5.2% |
| SiO₂ (wt %)^{$$} | 3-7% |
| Ferrite (wt %, XRD)^{$$$} | 80-96% |
| Wustite (FeO, wt %, XRD)^{$$$$} | 2-13% |
| Goethite (FeOOH, wt %, XRD)^{$$$$$} | 0-11% |
| Cementite (Fe₃C, wt %, XRD)⁺ | 0-80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption′ and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results.
Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results.
Porosity may be defined as the ratio of apparent density to actual density:
$\text{Porosity} = \frac{\text{apparent density}}{\text{actual density}}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results.
d_{pore, 90% volume} is the pore diameter above which 90% of the total pore volume exists.
*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results.
d_{pore, 50% surface area} is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
Fe³⁺ (wt %) preferably determined by the mass balance relation between and among Total Fe (wt %), Metallic Fe (wt %), Fe²⁺ (wt %) and Fe³⁺ (wt %).
Specifically the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) − Metallic Fe (wt %) − Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods.
In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$$}Goethite (FeOOH, wt %, XRD) preferably determined by x-ray diffraction (XRD).
⁺Cementite (Fe₃C, wt %, XRD) preferably determined by x-ray diffraction (XRD).

The properties set forth in Table 9, may also be present in embodiments with, in addition to, or instead of the properties in Tables 8 and/or 8A. Greater and lesser values for these properties may also be present in various embodiments.

In certain embodiments the DRI may be produced by the reduction of a DR Grade pellet, in which case the resulting DRI may have material properties as described in Table 10 below. The use of reduced DR grade DRI may be advantageous due to the higher Fe content in the pellet which increases the energy density of the battery.

TABLE 10

| Material Property | Embodiment Range |
|---|---|
| Specific surface area* | 0.21-25 m²/g as received or |
| | 0.19-25 m²/g after performing |
| | a pre-change formation step |
| Actual density** | 4.6-7.1 g/cc |
| Apparent density*** | 2.3-5.7 g/cc |
| Minimum d_{pore, 90% volume}**** | 50 nm-50 μm |
| Minimum d_{pore, 50% surface area}***** | 1 nm-10 μm |
| Total Fe (wt %)^{#} | 80-94% |
| Metallic Fe (wt %)^{##} | 64-94% |
| Metallization (%)^{###} | 80-100% |
| Carbon (wt %)^{####} | 0-5% |
| Fe²⁺ (wt %)^{#####} | 0-8% |
| Fe³⁺ (wt %)^{$} | 0-10% |
| SiO₂ (wt %)^{$$} | 1-4% |
| Ferrite (wt %, XRD)^{$$$} | 22-80% |
| Wustite (FeO, wt %, XRD)^{$$$$} | 0-13% |
| Goethite (FeOOH, wt %, XRD)^{$$$$$} | 0-23% |
| Cementite (Fe₃C, wt %, XRD)⁺ | «80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption′ and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results.
Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results.
Porosity may be defined as the ratio of apparent density to actual density:
$\text{Porosity} = \frac{\text{apparent density}}{\text{actual density}}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results.
d_{pore, 90% volume} is the pore diameter above which 90% of the total pore volume exists.
*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results.
d_{pore, 50% surface area} is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
^{$}Fe³⁺ (wt %) preferably determined by the mass balance relation between and among Total Fe (wt %), Metallic Fe (wt %), Fe²⁺ (wt %) and Fe³⁺ (wt %).
Specifically the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) − Metallic Fe (wt %) − Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods.
In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$$}Goethite (FeOOH, wt %, XRD) preferably determined by x-ray diffraction (XRD).
⁺Cementite (Fe₃C, wt %, XRD) preferably determined by x-ray diffraction (XRD).

The properties set forth in Table 10, may also be present in embodiments with, in addition to, or instead of the properties in Tables 8, 8A, and/or 9. Greater and lesser values for these properties may also be present in various embodiments.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

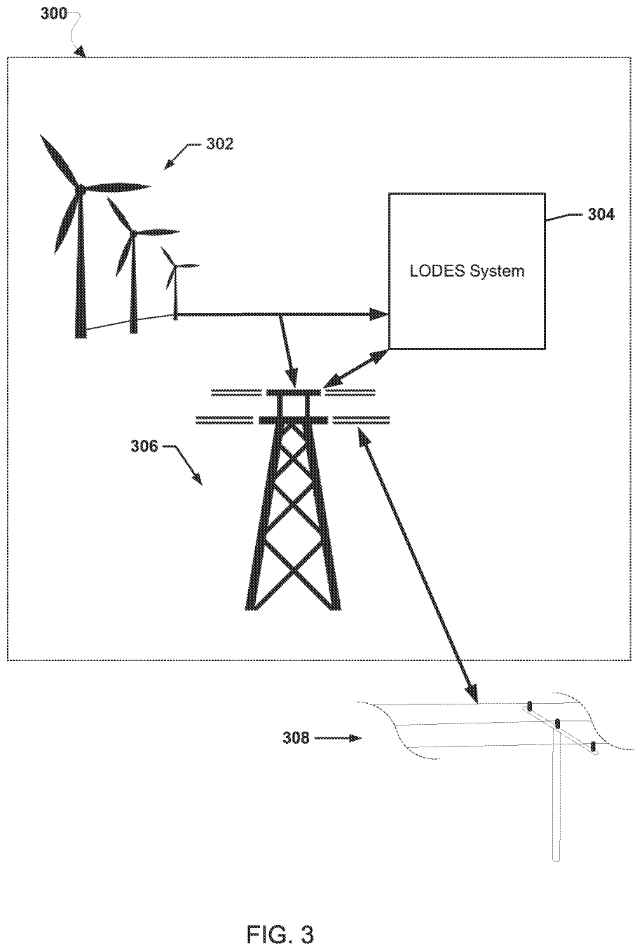

FIGS. 3-11 illustrate various example systems in which one or more aspects of the various embodiments may be used as part of bulk energy storage systems, such as LODES systems, SDES systems, etc. For example, various embodiments described herein with reference to FIGS. 1-2 may be used as batteries for bulk energy storage systems, such as LODES systems, SDES systems, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 3 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to the grid 308. The wind farm 302 may generate power and the wind farm 302 may output generated power to the LODES system 304 and/or the transmission facilities 306. The LODES system 304 may store power received from the wind farm 302 and/or the transmission facilities 306. The LODES system 304 may output stored power to the transmission facilities 306. The transmission facilities 306 may output power received from one or both of the wind farm 302 and LODES system 304 to the grid 308 and/or may receive power from the grid 308 and output that power to the LODES system 304. Together the wind farm 302, the LODES system 304, and the transmission facilities 306 may constitute a power plant 300 that may be a combined power generation, transmission, and storage system. The power generated by the wind farm 302 may be directly fed to the grid 308 through the transmission facilities 306, or may be first stored in the LODES system 304. In certain cases the power supplied to the grid 308 may come entirely from the wind farm 302, entirely from the LODES system 304, or from a combination of the wind farm 302 and the LODES system 304. The dispatch of power from the combined wind farm 302 and LODES system 304 power plant 300 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 300, the LODES system 304 may be used to reshape and “firm” the power produced by the wind farm 302. In one such example, the wind farm 302 may have a peak generation output (capacity) of 260 megawatts (MW) and a capacity factor (CF) of 41%. The LODES system 304 may have a power rating (capacity) of 106 MW, a rated duration (energy/power ratio) of 150 hours (h), and an energy rating of 15,900 megawatt hours (MWh). In another such example, the wind farm 302 may have a peak generation output (capacity) of 300 MW and a capacity factor (CF) of 41%. The LODES system 304 may have a power rating of 106 MW, a rated duration (energy/power ratio) of 200 h and an energy rating of 21,200 MWh. In another such example, the wind farm 302 may have a peak generation output (capacity) of 176 MW and a capacity factor (CF) of 53%. The LODES system 304 may have a power rating (capacity) of 88 MW, a rated duration (energy/power ratio) of 150 h and an energy rating of 13,200 MWh. In another such example, the wind farm 302 may have a peak generation output (capacity) of 277 MW and a capacity factor (CF) of 41%. The LODES system 304 may have a power rating (capacity) of 97 MW, a rated duration (energy/power ratio) of 50 h and an energy rating of 4,850 MWh. In another such example, the wind farm 302 may have a peak generation output (capacity) of 315 MW and a capacity factor (CF) of 41%. The LODES system 304 may have a power rating (capacity) of 110 MW, a rated duration (energy/power ratio) of 25 h and an energy rating of 2,750 MWh.

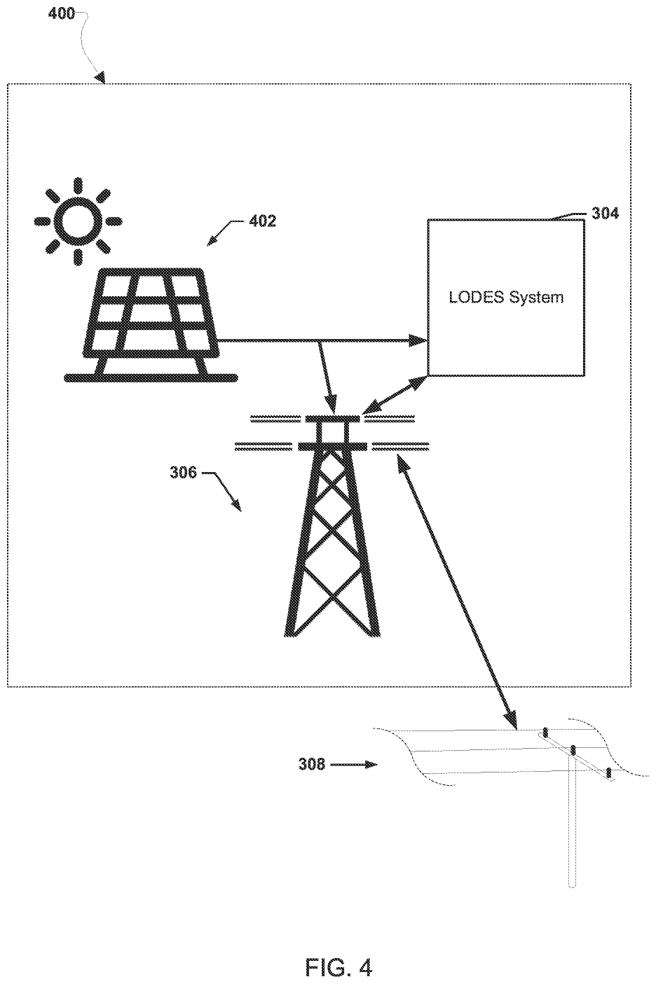

FIG. 4 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The system of FIG. 4 may be similar to the system of FIG. 3, except a photovoltaic (PV) farm 402 may be substituted for the wind farm 302. The LODES system 304 may be electrically connected to the PV farm 402 and one or more transmission facilities 306. The PV farm 402 may be electrically connected to the transmission facilities 306. The transmission facilities 306 may be electrically connected to the grid 308. The PV farm 402 may generate power and the PV farm 402 may output generated power to the LODES system 304 and/or the transmission facilities 306. The LODES system 304 may store power received from the PV farm 402 and/or the transmission facilities 306. The LODES system 304 may output stored power to the transmission facilities 306. The transmission facilities 306 may output power received from one or both of the PV farm 402 and LODES system 304 to the grid 308 and/or may receive power from the grid 308 and output that power to the LODES system 304. Together the PV farm 402, the LODES system 304, and the transmission facilities 306 may constitute a power plant 400 that may be a combined power generation, transmission, and storage system. The power generated by the PV farm 402 may be directly fed to the grid 308 through the transmission facilities 306, or may be first stored in the LODES system 304. In certain cases the power supplied to the grid 308 may come entirely from the PV farm 402, entirely from the LODES system 304, or from a combination of the PV farm 402 and the LODES system 304. The dispatch of power from the combined PV farm 402 and LODES system 304 power plant 400 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 400, the LODES system 304 may be used to reshape and “firm” the power produced by the PV farm 402. In one such example, the PV farm 402 may have a peak generation output (capacity) of 490 MW and a capacity factor (CF) of 24%. The LODES system 304 may have a power rating (capacity) of 340 MW, a rated duration (energy/power ratio) of 150 h and an energy rating of 51,000 MWh. In another such example, the PV farm 402 may have a peak generation output (capacity) of 680 MW and a capacity factor (CF) of 24%. The LODES system 304 may have a power rating (capacity) of 410 MW, a rated duration (energy/power ratio) of 200 h, and an energy rating of 82,000 MWh. In another such example, the PV farm 402 may have a peak generation output (capacity) of 330 MW and a capacity factor (CF) of 31%. The LODES system 304 may have a power rating (capacity) of 215 MW, a rated duration (energy/power ratio) of 150 h, and an energy rating of 32,250 MWh. In another such example, the PV farm 402 may have a peak generation output (capacity) of 510 MW and a capacity factor (CF) of 24%. The LODES system 304 may have a power rating (capacity) of 380 MW, a rated duration (energy/power ratio) of 50 h, and an energy rating of 19,000 MWh. In another such example, the PV farm 402 may have a peak generation output (capacity) of 630 MW and a capacity factor (CF) of 24%. The LODES system 304 may have a power rating (capacity) of 380 MW, a rated duration (energy/power ratio) of 25 h, and an energy rating of 9,500 MWh.

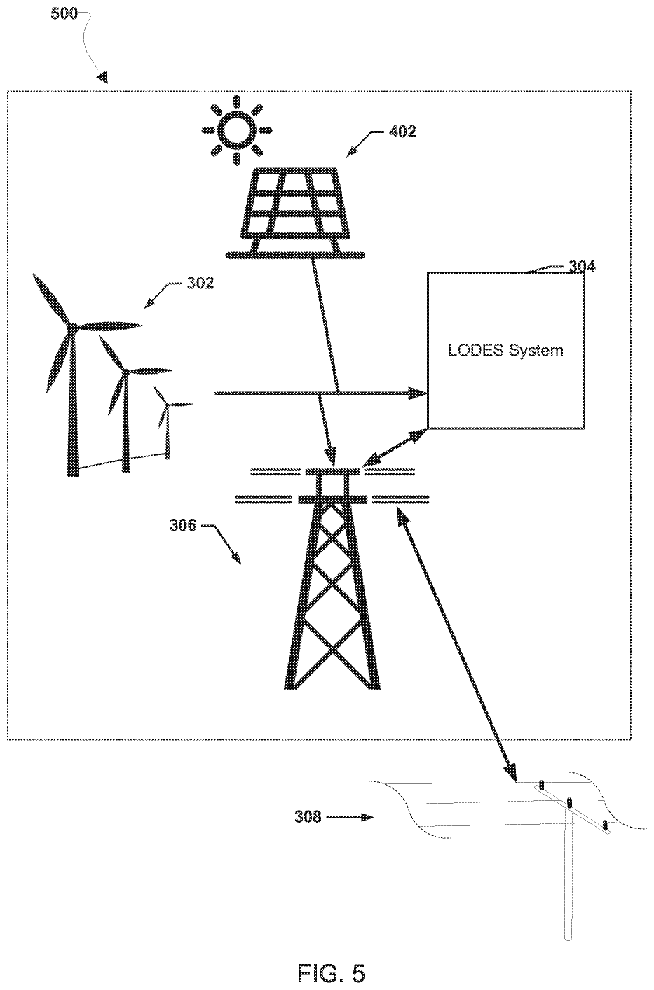

FIG. 5 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The system of FIG. 5 may be similar to the systems of FIGS. 3 and 4, except the wind farm 302 and the photovoltaic (PV) farm 402 may both be power generators working together in the power plant 500. Together the PV farm 402, wind farm 302, the LODES system 304, and the transmission facilities 306 may constitute the power plant 500 that may be a combined power generation, transmission, and storage system. The power generated by the PV farm 402 and/or the wind farm 302 may be directly fed to the grid 308 through the transmission facilities 306, or may be first stored in the LODES system 304. In certain cases the power supplied to the grid 308 may come entirely from the PV farm 402, entirely from the wind farm 302, entirely from the LODES system 304, or from a combination of the PV farm 402, the wind farm 302, and the LODES system 304. The dispatch of power from the combined wind farm 302, PV farm 402, and LODES system 304 power plant 500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 500, the LODES system 304 may be used to reshape and “firm” the power produced by the wind farm 302 and the PV farm 402. In one such example, the wind farm 302 may have a peak generation output (capacity) of 126 MW and a capacity factor (CF) of 41% and the PV farm 402 may have a peak generation output (capacity) of 126 MW and a capacity factor (CF) of 24%. The LODES system 304 may have a power rating (capacity) of 63 MW, a rated duration (energy/power ratio) of 150 h, and an energy rating of 9,450 MWh. In another such example, the wind farm 302 may have a peak generation output (capacity) of 170 MW and a capacity factor (CF) of 41% and the PV farm 402 may have a peak generation output (capacity) of 110 MW and a capacity factor (CF) of 24%. The LODES system 304 may have a power rating (capacity) of 57 MW, a rated duration (energy/power ratio) of 200 h, and an energy rating of 11,400 MWh. In another such example, the wind farm 302 may have a peak generation output (capacity) of 105 MW and a capacity factor (CF) of 51% and the PV farm 402 may have a peak generation output (capacity) of 70 MW and a capacity factor (CF) of 31 The LODES system 304 may have a power rating (capacity) of 61 MW, a rated duration (energy/power ratio) of 150 h, and an energy rating of 9,150 MWh. In another such example, the wind farm 302 may have a peak generation output (capacity) of 135 MW and a capacity factor (CF) of 41% and the PV farm 402 may have a peak generation output (capacity) of 90 MW and a capacity factor (CF) of 24%. The LODES system 304 may have a power rating (capacity) of 68 MW, a rated duration (energy/power ratio) of 50 h, and an energy rating of 3,400 MWh. In another such example, the wind farm 302 may have a peak generation output (capacity) of 144 MW and a capacity factor (CF) of 41% and the PV farm 402 may have a peak generation output (capacity) of 96 MW and a capacity factor (CF) of 24%. The LODES system 304 may have a power rating (capacity) of 72 MW, a rated duration (energy/power ratio) of 25 h, and an energy rating of 1,800 MWh.

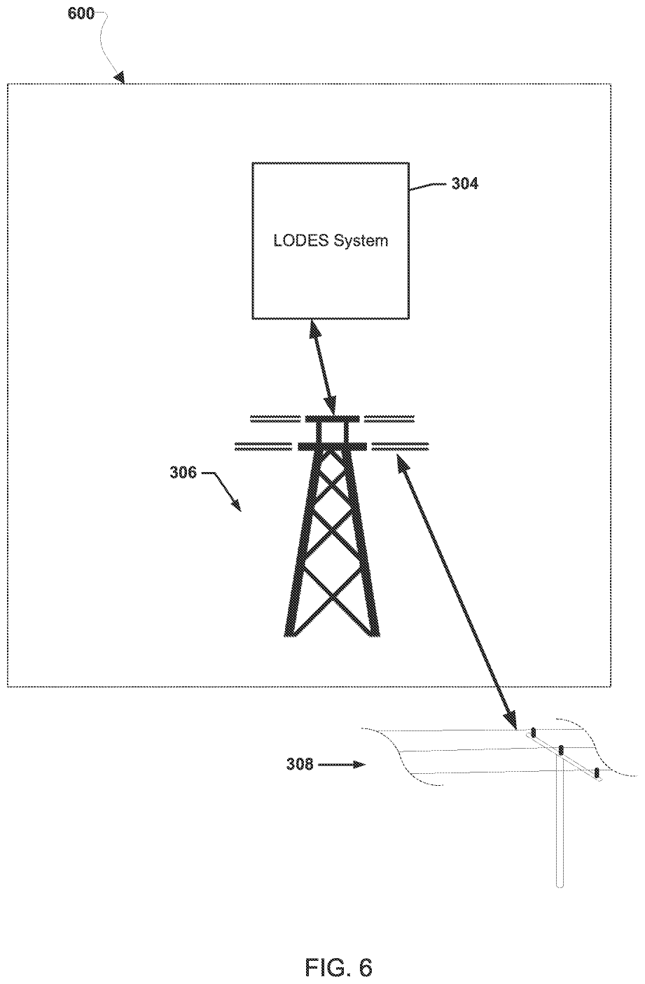

FIG. 6 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to one or more transmission facilities 306. In this manner, the LODES system 304 may operate in a “stand-alone” manner to arbiter energy around market prices and/or to avoid transmission constraints. The LODES system 304 may be electrically connected to one or more transmission facilities 306. The transmission facilities 306 may be electrically connected to the grid 308. The LODES system 304 may store power received from the transmission facilities 306. The LODES system 304 may output stored power to the transmission facilities 306. The transmission facilities 306 may output power received from the LODES system 304 to the grid 308 and/or may receive power from the grid 308 and output that power to the LODES system 304.

Together the LODES system 304 and the transmission facilities 306 may constitute a power plant 900. As an example, the power plant 900 may be situated downstream of a transmission constraint, close to electrical consumption. In such an example downstream situated power plant 600, the LODES system 304 may have a duration of 24 h to 500 h and may undergo one or more full discharges a year to support peak electrical consumptions at times when the transmission capacity is not sufficient to serve customers. Additionally in such an example downstream situated power plant 600, the LODES system 304 may undergo several shallow discharges (daily or at higher frequency) to arbiter the difference between nighttime and daytime electricity prices and reduce the overall cost of electrical service to customer. As a further example, the power plant 600 may be situated upstream of a transmission constraint, close to electrical generation. In such an example upstream situated power plant 600, the LODES system 304 may have a duration of 24 h to 500 h and may undergo one or more full charges a year to absorb excess generation at times when the transmission capacity is not sufficient to distribute the electricity to customers. Additionally in such an example upstream situated power plant 600, the LODES system 304 may undergo several shallow charges and discharges (daily or at higher frequency) to arbiter the difference between nighttime and daytime electricity prices and maximize the value of the output of the generation facilities.

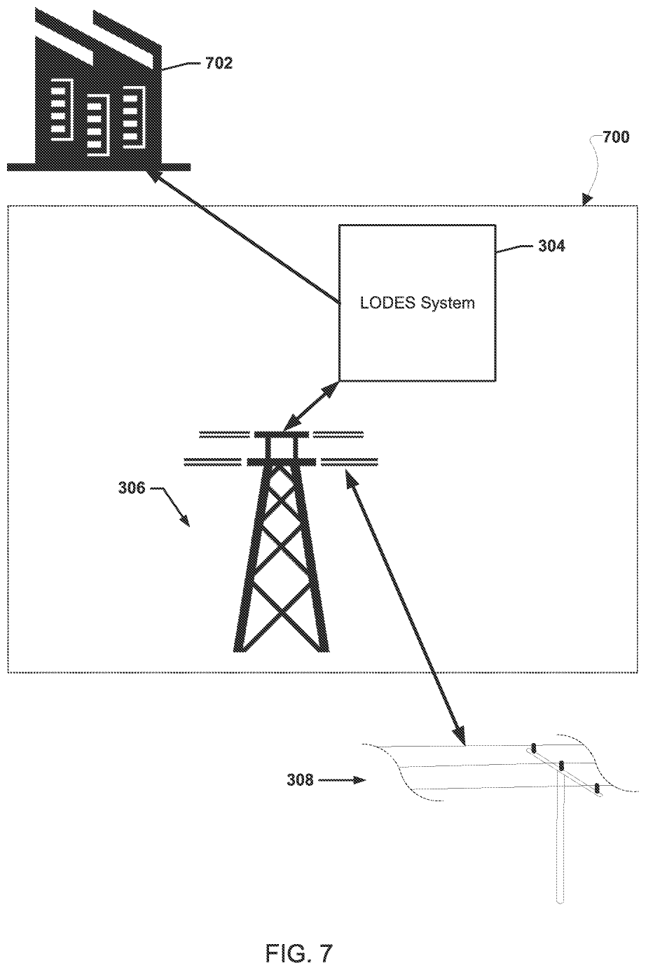

FIG. 7 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a commercial and industrial (C&I) customer 702, such as a data center, factory, etc. The LODES system 304 may be electrically connected to one or more transmission facilities 306. The transmission facilities 306 may be electrically connected to the grid 308. The transmission facilities 306 may receive power from the grid 308 and output that power to the LODES system 304. The LODES system 304 may store power received from the transmission facilities 306. The LODES system 304 may output stored power to the C&I customer 702. In this manner, the LODES system 304 may operate to reshape electricity purchased from the grid 308 to match the consumption pattern of the C&I customer 702.

Together, the LODES system 304 and transmission facilities 306 may constitute a power plant 700. As an example, the power plant 700 may be situated close to electrical consumption, i.e., close to the C&I customer 702, such as between the grid 308 and the C&I customer 702. In such an example, the LODES system 304 may have a duration of 24 h to 500 h and may buy electricity from the markets and thereby charge the LODES system 304 at times when the electricity is cheaper. The LODES system 304 may then discharge to provide the C&I customer 702 with electricity at times when the market price is expensive, therefore offsetting the market purchases of the C&I customer 702. As an alternative configuration, rather than being situated between the grid 308 and the C&I customer 702, the power plant 700 may be situated between a renewable source, such as a PV farm, wind farm, etc., and the transmission facilities 306 may connect to the renewable source. In such an alternative example, the LODES system 304 may have a duration of 24 h to 500 h, and the LODES system 304 may charge at times when renewable output may be available. The LODES system 304 may then discharge to provide the C&I customer 702 with renewable generated electricity so as to cover a portion, or the entirety, of the C&I customer 702 electricity needs.

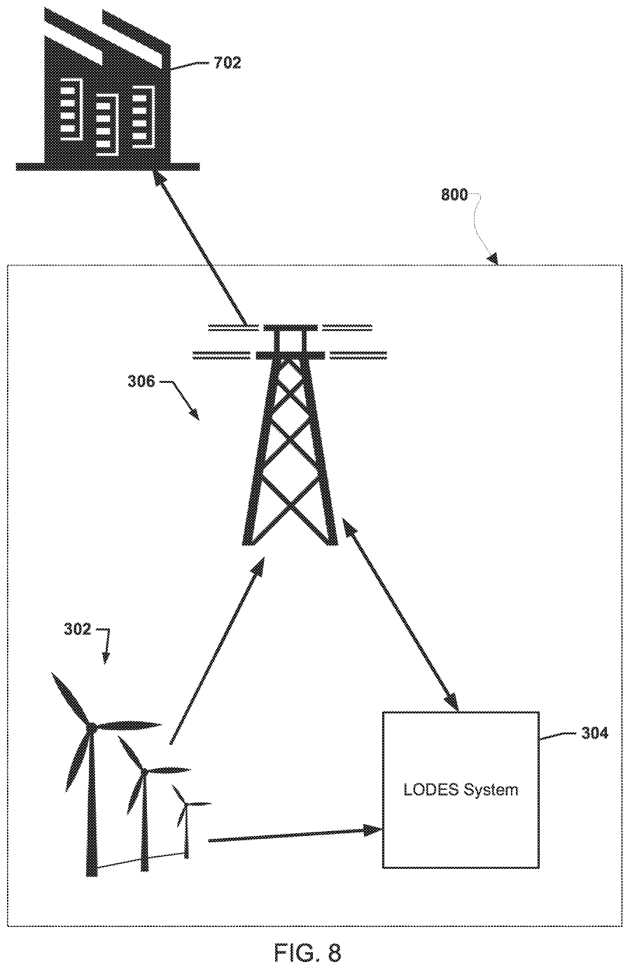

FIG. 8 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to a C&I customer 702. The wind farm 302 may generate power and the wind farm 302 may output generated power to the LODES system 304 and/or the transmission facilities 306. The LODES system 304 may store power received from the wind farm 302.

The LODES system 304 may output stored power to the transmission facilities 306. The transmission facilities 306 may output power received from one or both of the wind farm 302 and LODES system 304 to the C&I customer 702. Together the wind farm 302, the LODES system 304, and the transmission facilities 306 may constitute a power plant 800 that may be a combined power generation, transmission, and storage system. The power generated by the wind farm 302 may be directly fed to the C&I customer 702 through the transmission facilities 306, or may be first stored in the LODES system 304. In certain cases, the power supplied to the C&I customer 702 may come entirely from the wind farm 302, entirely from the LODES system 304, or from a combination of the wind farm 302 and the LODES system 304. The LODES system 304 may be used to reshape the electricity generated by the wind farm 302 to match the consumption pattern of the C&I customer 702. In one such example, the LODES system 304 may have a duration of 24 h to 500 h and may charge when renewable generation by the wind farm 302 exceeds the C&I customer 702 load. The LODES system 304 may then discharge when renewable generation by the wind farm 302 falls short of C&I customer 702 load so as to provide the C&I customer 702 with a firm renewable profile that offsets a fraction, or all of, the C&I customer 702 electrical consumption.

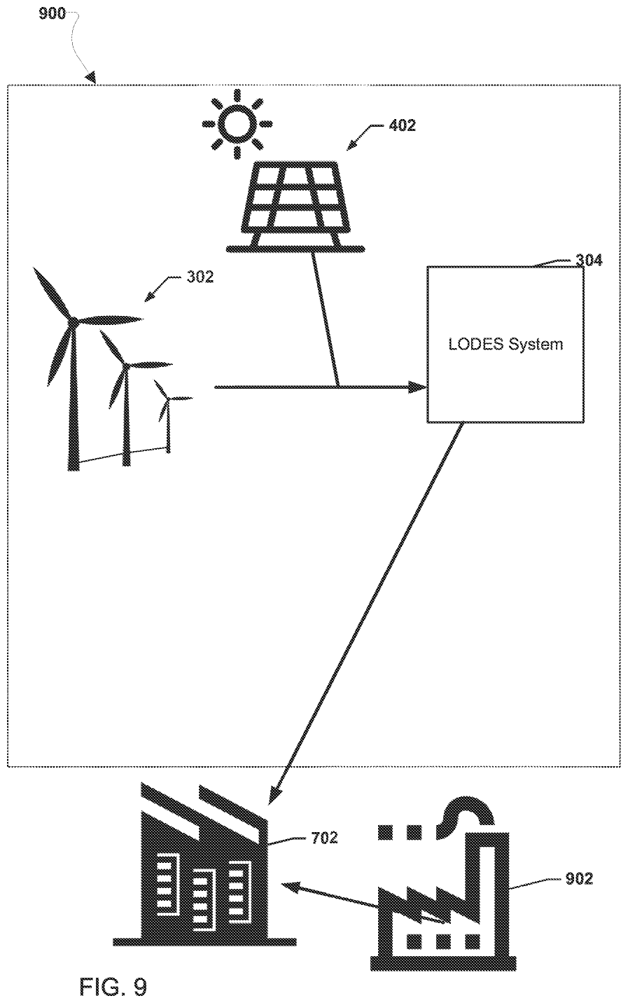

FIG. 9 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be part of a power plant 900 that is used to integrate large amounts of renewable generation in microgrids and harmonize the output of renewable generation by, for example a PV farm 402 and wind farm 302, with existing thermal generation by, for example a thermal power plant 902 (e.g., a gas plant, a coal plant, a diesel generator set, etc., or a combination of thermal generation methods), while renewable generation and thermal generation supply the C&I customer 702 load at high availability. Microgrids, such as the microgrid constituted by the power plant 900 and the thermal power plant 902, may provide availability that is 90% or higher. The power generated by the PV farm 402 and/or the wind farm 302 may be directly fed to the C&I customer 702, or may be first stored in the LODES system 304.

In certain cases the power supplied to the C&I customer 702 may come entirely from the PV farm 402, entirely from the wind farm 302, entirely from the LODES system 304, entirely from the thermal power plant 902, or from any combination of the PV farm 402, the wind farm 302, the LODES system 304, and/or the thermal power plant 902. As examples, the LODES system 304 of the power plant 900 may have a duration of 24 h to 500 h. As a specific example, the C&I customer 702 load may have a peak of 100 MW, the LODES system 304 may have a power rating of 14 MW and duration of 150 h, natural gas may cost $6/million British thermal units (MMBTU), and the renewable penetration may be 58%. As another specific example, the C&I customer 702 load may have a peak of 100 MW, the LODES system 304 may have a power rating of 25 MW and duration of 150 h, natural gas may cost $8/MMBTU, and the renewable penetration may be 65%.

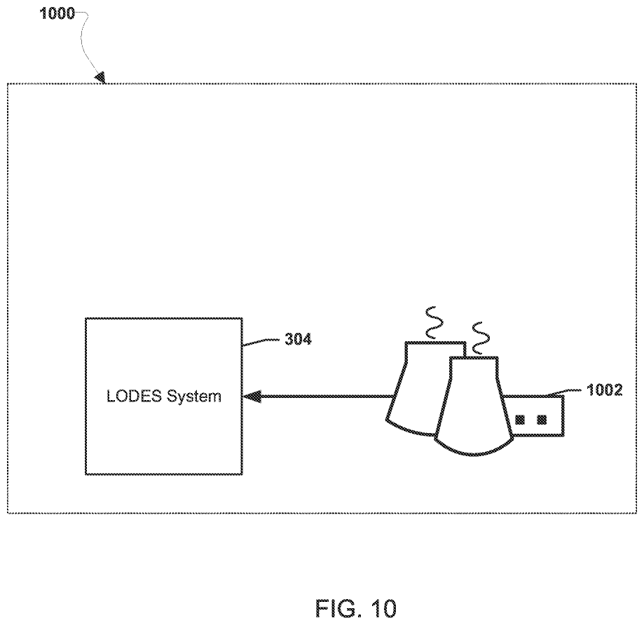

FIG. 10 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be used to augment a nuclear plant 1002 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 1000 constituted by the combined LODES system 304 and nuclear plant 1002. The nuclear plant 1002 may operate at high capacity factor and at the highest efficiency point, while the LODES system 304 may charge and discharge to effectively reshape the output of the nuclear plant 1002 to match a customer electrical consumption and/or a market price of electricity. As examples, the LODES system 304 of the power plant 1000 may have a duration of 24 h to 500 h. In one specific example, the nuclear plant 1002 may have 1,000 MW of rated output and the nuclear plant 1002 may be forced into prolonged periods of minimum stable generation or even shutdowns because of depressed market pricing of electricity. The LODES system 304 may avoid facility shutdowns and charge at times of depressed market pricing; and the LODES system 304 may subsequently discharge and boost total output generation at times of inflated market pricing.

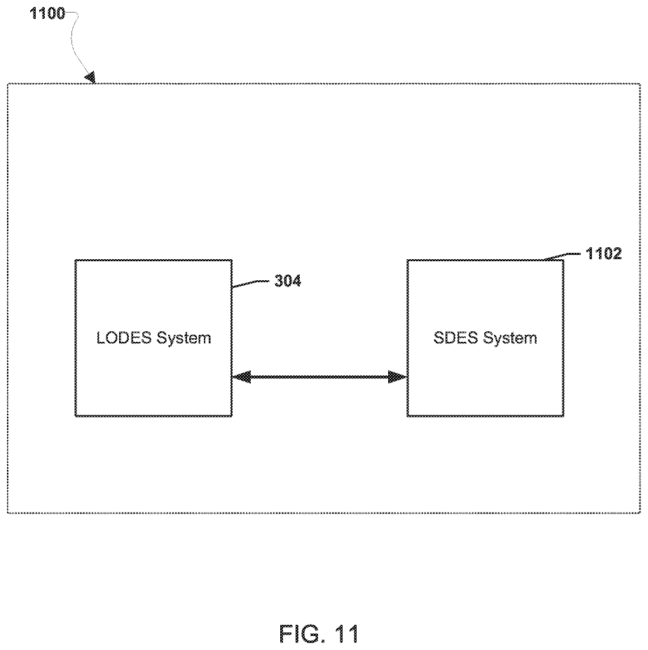

FIG. 11 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may operate in tandem with a SDES system 1102. Together the LODES system 304 and SDES system 1102 may constitute a power plant 1100. As an example, the LODES system 304 and SDES system 1102 may be co-optimized whereby the LODES system 304 may provide various services, including long-duration back-up and/or bridging through multi-day fluctuations (e.g., multi-day fluctuations in market pricing, renewable generation, electrical consumption, etc.), and the SDES system 1102 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 1102 may have durations of less than 10 hours and round-trip efficiencies of greater than 80%. The LODES system 304 may have durations of 24 h to 500 h and round-trip efficiencies of greater than 40%. In one such example, the LODES system 304 may have a duration of 150 hours and support customer electrical consumption for up to a week of renewable under-generation. The LODES system 304 may also support customer electrical consumption during intra-day under-generation events, augmenting the capabilities of the SDES system 1102. Further, the SDES system 1102 may supply customers during intra-day under-generation events and provide power conditioning and quality services such as voltage control and frequency regulation.

Various examples are provided below to illustrate aspects of the various embodiments. Example 1. A battery, comprising: a first electrode; an electrolyte; and a second electrode, wherein one or both of the first electrode and the second electrode comprises iron. Example 2. The battery of example 1 wherein the iron is in the form of iron ore. Example 3. The battery of example 1 wherein the iron is in the form of concentrate. Example 4. The battery of example 1 wherein the iron is in the form of at least one form selected from the group consisting of pellets, BF grade pellets, DR grade pellets, hematite, magnetite, wustite, martite, goethite, limonite, siderite, pyrite, ilmenite, and spinel manganese ferrite. Example 5. The battery of any of examples 2-4, the iron further comprising at least 0.1% SiO₂ by mass. Example 6. The battery of any of examples 2-4, the iron further comprising at least 0.25% SiO₂ by mass. Example 7. The battery of any of examples 2-4, the iron further comprising at least 0.% SiO₂ by mass. Example 8. The battery of any of examples 2-4, the iron further comprising at least 0.1% CaO by mass. Example 9. The battery of any of examples 2-4, the iron further comprising at least 0.25% CaO by mass. Example 10. The battery of any of examples 2-4, the iron further comprising at least 0.5% CaO by mass.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

Further, any step of any embodiment described herein can be used in any other embodiment. The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A battery, comprising:
a first electrode;
an electrolyte; and
a second electrode,
wherein one or both of the first electrode and the second electrode comprises iron.

2. The battery of claim 1 wherein the iron is in the form of iron ore.

3. The battery of claim 1 wherein the iron is in the form of concentrate.

4. The battery of claim 1 wherein the iron is in the form of at least one form selected from the group consisting of pellets, BF grade pellets, DR grade pellets, hematite, magnetite, wustite, martite, goethite, limonite, siderite, pyrite, ilmenite, and spinel manganese ferrite.

5. The battery of claim 2, the iron further comprising at least 0.1% SiO₂ by mass.

6. The battery of claim 2, the iron further comprising at least 0.25% SiO₂ by mass.

7. The battery of claim 2, the iron further comprising at least 0.5% SiO₂ by mass.

8. The battery of claim 2, the iron further comprising at least 0.1% CaO by mass.

9. The battery of claim 2, the iron further comprising at least 0.25% CaO by mass.

10. The battery of claim 2, the iron further comprising at least 0.5% CaO by mass.

11. (canceled)

12. (canceled)

13. The battery of claim 3, the iron further comprising at least 0.1% SiO₂ by mass.

14. The battery of claim 3, the iron further comprising at least 0.25% SiO₂ by mass.

15. The battery of claim 3, the iron further comprising at least 0.5% SiO₂ by mass.

16. The battery of claim 3, the iron further comprising at least 0.1% CaO by mass.

17. The battery of claim 3, the iron further comprising at least 0.25% CaO by mass.

18. The battery of claim 3, the iron further comprising at least 0.5% CaO by mass.

19. The battery of claim 4, the iron further comprising at least 0.1% SiO₂ by mass.

20. The battery of claim 4, the iron further comprising at least 0.5% SiO₂ by mass.

21. The battery of claim 4, the iron further comprising at least 0.1% CaO by mass.

22. The battery of claim 4, the iron further comprising at least 0.5% CaO by mass.
